(19) United States
(12) Patent Application Publication
(10) Pub. No.: US 2010/0298149 A1
(43) Pub. Date: Nov. 25, 2010

(54) COMBINATION TWIST STRUCTURE OF THE SUPER CONDUCTION CABLE

(76) Inventors: Do-Hyoung Kim, Gyeonggi-do (KR); Choon-Dong Kim, Gyeonggi-do (KR); Hyun-Man Jang, Gyeonggi-do (KR); In-Son Park, Seoul (KR); Bong-Ki Ji, Gyeonggi-do (KR); Nam-Yul Kim, Gyeongsangbuk-do (KR)

Correspondence Address: SHERR & VAUGHN, PLLC, 620 HERNDON PARKWAY, SUITE 320, HERNDON, VA, 20170, US

(21) Appl. No.: 12/518,353

(22) PCT Filed: Dec. 27, 2007
(86) PCT No.: PCT/KR2007/006874

§ 371 Date: Jun. 9, 2009

(30) Foreign Application Priority Data
Jan. 4, 2007 (KR) 10-2007-0001025

(51) Int. Cl. H01B 12/10; H01B 12/00

(52) U.S. Cl. 505/231; 174/125.1

(57) ABSTRACT

The present invention relates to a combination twist structure of a superconducting cable core. The present invention relates to a new type of a combination twist structure of a superconducting cable core capable of accommodating the thermal contraction of the cable core in the longitudinal direction without having a space for accommodation, thereby capable of reducing an outer diameter of the superconducting cable, and eliminating the use of an additional equipment for forming the space for accommodation. The present invention provides a combination twist structure of a superconducting cable core formed by twisting a plurality of cable cores. The cable cores are combined by repeatedly changing a twist direction of the cable cores, and the contraction of the cable cores in the longitudinal direction is accommodated by untwisting the cable cores.

### TECHNICAL FIELD

The present invention relates to a combination twist structure of a superconducting cable core. More particularly, the present invention relates to a new type of a combination twist structure of a superconducting cable core capable of accommodating the contraction of the cable core in the longitudinal direction without the need of the space for accommodating the contraction of the cable core when cooled from initial room temperature, thereby capable of reducing the outer diameter of the superconducting cable, eliminating the use of an additional equipment for forming the space for accommodation and relieving troubles and inconveniences in manufacturing the superconducting cable.

### BACKGROUND ART

Generally, high-temperature superconductivity indicates a phenomenon that electrical resistance of a suprceonducting conductor becomes zero (0) at an extremely low temperature (−196° C. or below). A superconducting cable is a kind of an electrical cable manufactured to transmit huge amounts of power by using the superconducting conductor.

The superconducting cable 10 includes, as illustrated in FIGS. 1 to 3, a cable core 12 serving as a conductor to provide electric power devices with electric power, an outer sheath 14 enclosing the superconducting cable 10 to protect the inside of the superconducting cable 10 from the outside thereof, and an inner sheath 18 rolled between the outer sheath 14 and the cable core 12 to serve as a heat insulator by forming a vacuum portion 16 between the inner sheath 18 and the outer sheath 14.

The cable core 12 is typically fixed in a twisted form to be easily inserted into the inner sheath 18.

In such a conventional cable 10, the cable core 12 is contracted in the longitudinal direction due to cooling. When the thermal contraction of the cable core 12 contracted in the longitudinal direction is not adequately accommodated, a tension to the cable core 12 may be generated, thereby causing damage to a conductor or a superconductive wire included in the cable core 12.

In order to solve the above-mentioned problem, conventionally, the cable core 12 has been twisted only in one direction to form a space for accommodation 20 inside the cable cores 12, as illustrated in FIGS. 1 to 3, so that the space for accommodation 20 accommodates the contraction of the cable cores 12 in the longitudinal direction.

However, when the space for accommodation 20 is formed to accommodate the contraction of the cable core 12 in the longitudinal direction by twisting the cable core 12, the center diameter d and the outer diameter D of the combined cable core 12 are increased, thereby resulting in the increase of the outer diameter D1 of the superconducting cable 10. In addition, when twisting the cable core 12, additional equipments are needed to form the space for accommodation 20, which causes troubles and inconveniences in manufacturing.

### DISCLOSURE OF INVENTION

### Technical Problem

The present invention provides a combination twist structure of a superconducting cable core capable of accommodating the contraction of the cable core in the longitudinal direction without the space for accommodation, thereby capable of reducing an outer diameter of the superconducting cable.

The present invention also provides a combination twist structure of a superconducting cable core capable of relieving the inconvenience of using additional equipment for forming the space for accommodation.

### Technical Solution

In an aspect of the present invention, a combination twist structure of a superconducting cable core is formed by twisting a plurality of cable cores. The cable cores are combined by repeatedly changing the twist direction of the cable cores. The contraction of the cable core in the longitudinal direction is accommodated by untwisting the cable cores.

In addition, in the combination twist structure, a twist angle of the cable cores is in a range of 2 degrees to 10 degrees.

Furthermore, in the combination twist structure, the unit length of the cable cores by which the twist direction is changed is twice or three times longer than the twist pitch of the cable cores.

### ADVANTAGEOUS EFFECTS

According to the present invention, when a superconducting cable is cooled, the contraction of the superconducting cable core in the longitudinal direction may be accommodated without a space for accommodation. Thus, the outer diameter of the superconducting cable core may be decreased since the space for accommodation is unnecessary.

Since the space for accommodation is not required, additional equipment for forming the space for accommodation may not be used, and troubles and inconveniences in manufacturing the superconducting cable may be relieved.

### BRIEF DESCRIPTION OF THE DRAWINGS

The above and other advantages of the present invention will become more apparent by describing in detail exemplary embodiments thereof with reference to the accompanying drawings, in which:

FIG. 1 is a schematic side cross-sectional view illustrating a combination twist structure of a superconducting cable core according to a prior art;

FIG. 2 is a schematic cross-sectional view illustrating the combination twist structure of the superconducting cable core illustrated in FIG. 1 before the superconducting cable core is cooled;

FIG. 3 is a schematic cross-sectional view illustrating the combination twist structure of the superconducting cable core, which corresponds to FIG. 2, after the superconducting cable core is cooled;

FIG. 4 is a schematic cross-sectional view illustrating a combination twist structure of a superconducting cable core according to the present invention;

FIG. 5 is a schematic side cross-sectional view illustrating the combination twist structure of the superconducting cable core according to the present invention before the superconducting cable core is cooled; and

FIG. 6 is a schematic side cross-sectional view illustrating the combination twist structure of the superconducting cable core, which corresponds to FIG. 5, after the superconducting cable core is cooled.

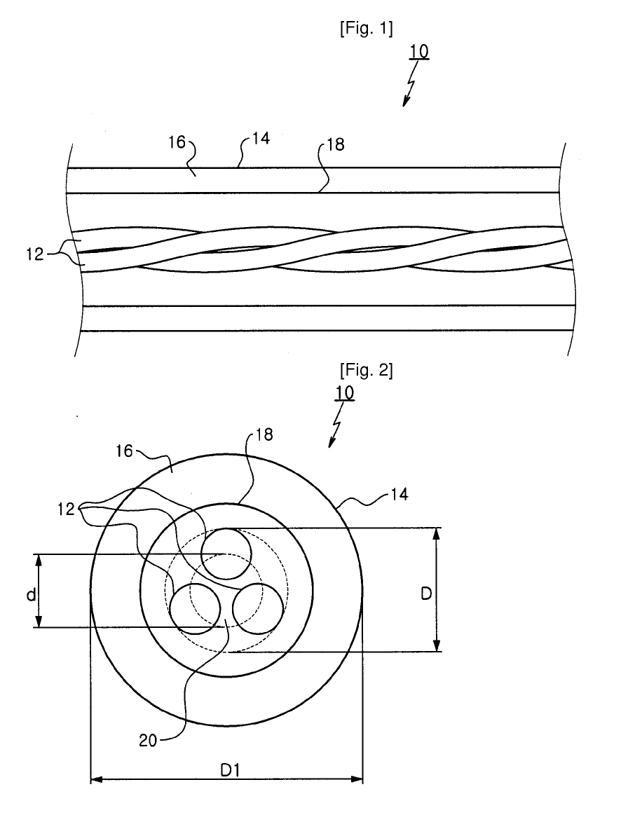

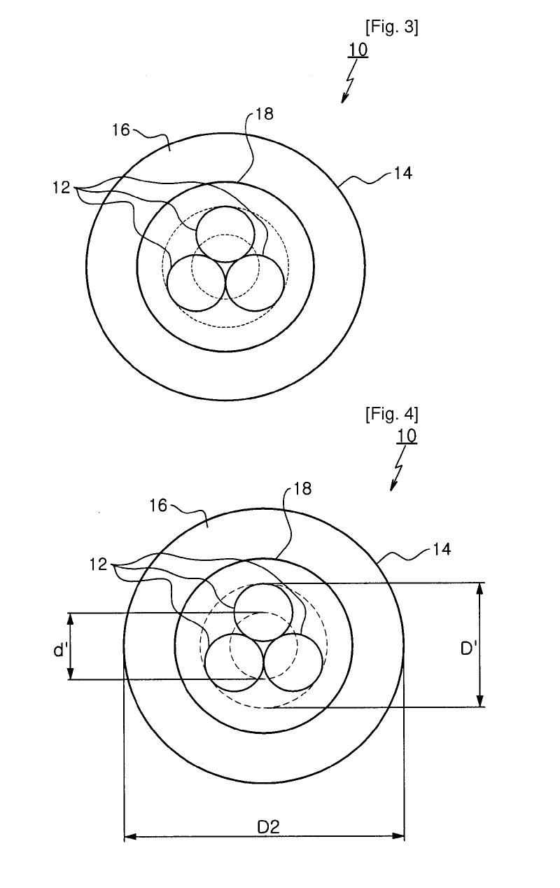

### MODE FOR THE INVENTION

Hereinafter, a combination twist structure of a superconducting cable core according to the present invention will be described in detail with reference to the accompanying drawings.

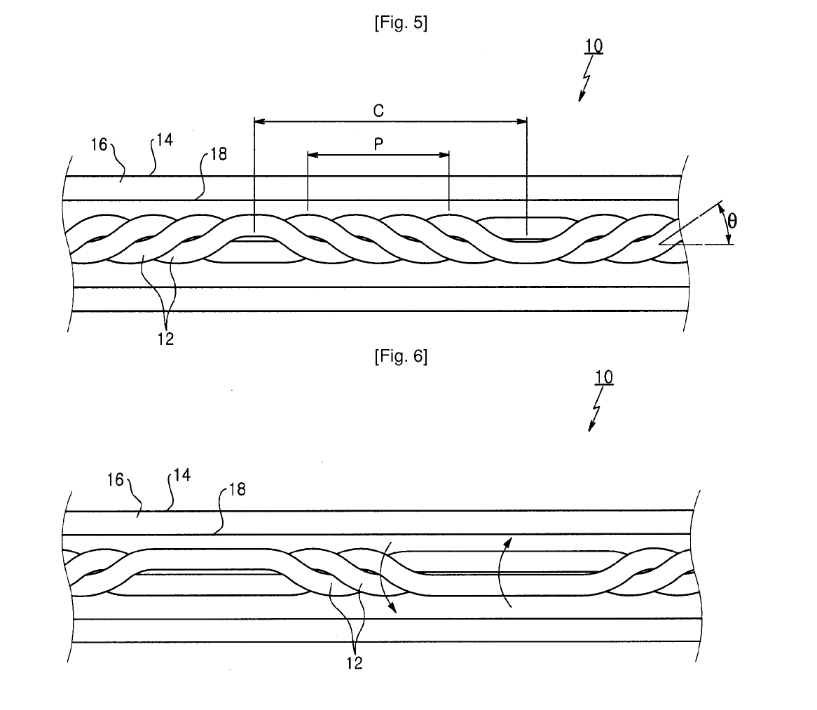

FIG. 4 is a schematic cross-sectional view illustrating a combination twist structure of a superconducting cable core 12 according to the present invention. FIG. 5 is a schematic side cross-sectional view illustrating the combination twist structure of the superconducting cable core 12 according to the present invention before the superconducting cable core is cooled. FIG. 6 is a schematic side cross-sectional view illustrating the combination twist structure of the superconducting cable core 12, which corresponds to FIG. 5, after the superconducting cable core is cooled.

As shown in FIGS. 4 to 6, the superconducting cable 10 having a combination twist structure of the present invention includes a cable core 12 serving as a conductor, an outer sheath 14 disposed at an outermost of the superconducting cable 10 to protect an inside of the superconducting cable 10 from an outside thereof, and an inner sheath 18 rolled between the outer sheath 14 and the cable core 12 to serve as a heat insulator by forming a vacuum portion 16 between the inner sheath 18 and the outer sheath 14.

Outer surfaces of a plurality of cable cores 12 are contacted with each other and the cable cores 12 are twisted to form combined cable cores. The cable cores 12 are not twisted in only one twist direction, but are twisted by repeatedly changing the twist direction of the cable cores 12 with a predetermined period C. In other words, the cable cores are repeatedly twisted in a clockwise direction and then in a counterclockwise direction with a predetermined interval.

The period C, that is the unit length by which the twist direction of the combined cable cores 12 is changed, may be a half to several tens of the combined twist pitch P, that is, the longitudinal length by which a piece of the cable cores 12 rotates once. Particularly, in case that the period C is less than twice of the twist pitch P, the combined cable cores 12 is not fixed well, and in case that the period C is more than three times of the twist pitch P, the contraction of the cable cores 12 in the longitudinal direction is not evenly accommodated when the cable cores 12 are untwisted due to cooling. In other words, when the period C is too long, the contraction at a position distant from the position at which the twist direction is changed is not accommodated well and, thus, may be harmful to the wire. Thus, considering various factors, for example, such as the contraction of the cable cores 12, the period C may preferably be twice or three times longer than the combined twist pitch P.

In addition, a combined twist angle θ which may be obtained from the equation tan θ=πd′/P (wherein d′ represents the center diameter of combined cable cores, and P represents for the pitch of combined cable cores), may be set to be about 2 degrees to 10 degrees. In case that the combined twist angle θ is less than or equal to 2 degrees, the twisted cable cores 12 may not be fixed well, and in case that the combined twist angle θ is greater than or equal to 10 degrees, the cable cores 12 may be excessively twisted, thereby damaging the wire in the cable cores 12. Thus, considering various factors, for example, such as compactness and looseness for twist of the cable cores 12, the combined twist angle θ may preferably be in a range of 5 degrees to 6 degrees.

As in the present invention, when the pieces of the cable cores 12 are alternately twisted in one direction and then in the opposite direction repeatedly with the predetermined period C, the cable cores 12 are untwisted as the contraction of the cable cores 12 in the longitudinal direction as the cable cores 12 are cooled, thereby resulting in a state as shown in FIG. 6. When the pieces of cable cores 12 are evenly twisted, the pieces of cable cores 12 are evenly untwisted to uniformly accommodate the contraction of the cable cores 12 in the longitudinal direction. Thus, tension does not occur in the cable cores 12, and damage to the conductor or the superconducting wire of the cable cores 12 may be prevented.

Preferably, the cable cores 12 are not completely untwisted, so that the cable cores 12 may remain fixed to each other when the cable cores 12 are cooled. At least some of twisted portions may preferably remain twisted to maintain a twisted state of the cable cores 12.

### INDUSTRIAL APPLICABILITY

According to the combination twist structure of the present invention, when the superconducting cable is cooled, a space for accommodation is not required to accommodate the contraction of the cable core in the longitudinal direction. As a result, the center diameter and the outer diameter of the combination cable cores and the outer diameter of a superconducting cable can be reduced.

In addition, since an additional equipment for forming the space for accommodation is not required, troubles and inconveniences in manufacturing the superconducting cable may be relieved.

1-3. (canceled)

4. A superconducting cable, comprising:
a first superconducting cable core; and
at least a second superconducting cable core twisted together with the first superconducting cable core, wherein the twist direction of the cable cores repeatedly changes along a longitudinal direction of the superconducting cable, and contraction of the cable cores in the longitudinal direction is accommodated by an untwisting of the cable cores.

5. The superconducting cable of claim 4, wherein the twist angle of the cable cores is in a range of 2 degrees to 10 degrees.

6. The superconducting cable of claim 4, wherein the unit length of the cable cores in which the twist direction is changed is approximately twice the twist pitch of the cable cores.

7. The superconducting cable of claim 4, wherein the unit length of the cable cores in which the twist direction is changed is approximately three times longer than the twist pitch of the cable cores.

8. The superconducting cable of claim 4, wherein the unit length of the cable cores in which the twist direction is changed is in the range of two to three times longer than the twist pitch of the cable cores.
